(19) United States
(12) Patent Application Publication
(10) Pub. No.: US 2025/0201901 A1
(43) Pub. Date: Jun. 19, 2025

(54) BATTERY MANUFACTURING METHOD

(71) Applicant: TOYOTA JIDOSHA KABUSHIKI KAISHA, Toyota-shi (JP)

(72) Inventor: Sadao FUJISAKI, Toyota-shi (JP)

(73) Assignee: TOYOTA JIDOSHA KABUSHIKI KAISHA, Toyota-shi (JP)

(21) Appl. No.: 18/826,191

(22) Filed: Sep. 6, 2024

(30) Foreign Application Priority Data
Dec. 13, 2023 (JP) 2023-210458

(51) Int. Cl. H01M 10/04; H01M 50/105

(52) U.S. Cl. CPC H01M 10/049; H01M 50/105

(57) ABSTRACT

A battery manufacturing method including an electrode body, an outer encasement, and a lid body includes: a preparation step of preparing the predetermined outer encasement; an insertion step of inserting the electrode body into the outer encasement; a pressing step of pressing the outer encasement under predetermined conditions after the insertion step; and a lid body disposing step of disposing the lid body in the opening before the pressing step or after the pressing step.

### CROSS-REFERENCE TO RELATED APPLICATION

This application claims priority to Japanese Patent Application No. 2023-210458 filed on Dec. 13, 2023, incorporated herein by reference in its entirety.

### BACKGROUND

### 1. Technical Field

The present disclosure relates to a battery manufacturing method.

### 2. Description of Related Art

In a battery such as a secondary battery or the like, an electrode body is usually accommodated in an inner space of an outer encasement. For example, Japanese Unexamined Patent Application Publication No. 2022-180650 (JP 2022-180650 A) discloses a rectangular secondary battery having a flat wound electrode body in which a cathode plate and an anode plate are wound with a separator interposed therebetween, a rectangular outer encasement having an opening and accommodating the wound electrode body, and a sealing plate sealing the opening. Further, JP 2022-180650 A discloses that the rectangular outer encasement has a bottom wall, a pair of first side walls extending from the bottom wall and opposed to each other, a pair of second side walls extending from the bottom wall and opposed to each other, and the opening opposite the bottom wall.

Japanese Unexamined Patent Application Publication No. 2023-062732 (JP 2023-062732 A) discloses a battery manufacturing method including fitting and joining, in which, in the joining, an outer encasement and a sealing plate are joined while pressing a pair of first side walls toward inside of the outer encasement. Also, Japanese Unexamined Patent Application Publication No. 2016-110777 (JP 2016-110777 A) discloses a battery manufacturing method for manufacturing a lithium-ion secondary battery, which includes pre-doping, in which lithium pre-doping is performed, and charging in which initial charging is performed while pressurizing a battery.

### SUMMARY

The rectangular outer encasement in JP 2022-180650 A has the bottom wall, the first side walls, the second side walls, and the opening. When the electrode body is inserted into the inner space of such an outer encasement through the opening, the size of the opening needs to be larger than the size of the electrode body. Accordingly, the volume of the inner space of the outer encasement is also usually larger than the volume of the electrode body. As a result, an excessive gap is formed in the inner space of the outer encasement, and thus volume efficiency of the battery is poorer.

The present disclosure has been made in view of the above circumstances, and a primary object thereof is to provide a battery manufacturing method that is capable of obtaining a battery having good volume efficiency.

### Form 1

A battery manufacturing battery manufacturing a battery that includes an electrode body, an outer encasement, and a lid body includes preparing the outer encasement that satisfies (i) to (iii) in which
(i) the outer encasement includes a first face, a second face opposite the first face, a third face connecting the first face and the second face, and a fourth face connecting the first face and the second face and also opposite the third face,
(ii) the outer encasement includes an inner space defined by the first face, the second face, the third face, and the fourth face, and an opening situated at an end portion of the inner space,
(iii) in a cross-section perpendicular to the first face and the third face at an end portion of the outer encasement, the outer encasement includes a corner portion with a curved shape on at least one of both end portions of a side made up of the third face, and also includes a corner portion with a curved shape on at least one of both end portions of a side made up of the fourth face,
inserting the electrode body into the inner space through the opening,
pressing at least one of the first face and the second face toward the electrode body, following the inserting, in a state in which relative positions of the third face and the fourth face are fixed, or in a state in which at least one of the third face and the fourth face is pressed toward the electrode body, and
placing the lid body in the opening prior to the pressing or following the pressing.

### Form 2

In the battery manufacturing method according to Form 1,
the outer encasement includes, in the cross-section perpendicular to the first face and the third face at the end portion of the outer encasement, the corner portions each with the curved shape at both end portions of the side made up of the third face, and also the corner portions each with the curved shape at both end portions of the side made up of the fourth face.

### Form 3

In the battery manufacturing method according to Form 2,
prior to the pressing, bending radii of the four corner portions are each no less than 0.5 mm and no more than 1.5 mm, and
following the pressing, the bending radii of the four corner portions are each no less than 0.1 mm and no more than 0.5 mm.

### Form 4

In the battery manufacturing method according to any one of Forms 1 to 3, the electrode body includes a solid electrolyte.

### Form 5

In the battery manufacturing method according to any one of Forms 1 to 4, the placing is performed following the pressing.

According to the present disclosure, a battery having good volume efficiency can be obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic perspective view illustrating a battery manufacturing method according to the present disclosure;

FIG. 1B is a schematic perspective view illustrating a battery manufacturing method according to the present disclosure;

FIG. 1C is a schematic cross-sectional view illustrating a battery manufacturing method;

FIG. 1D is a schematic cross-sectional view illustrating a battery manufacturing method;

FIG. 2A is a schematic cross-sectional view illustrating a battery manufacturing method according to the present disclosure;

FIG. 2B is a schematic cross-sectional view illustrating a battery manufacturing method according to the present disclosure;

FIG. 2C is a schematic cross-sectional view illustrating a battery manufacturing method according to the present disclosure;

FIG. 2D is a schematic cross-sectional view illustrating a battery manufacturing method according to the present disclosure;

FIG. 3A is an enlarged view of a portion of FIG. 2A;

FIG. 3B is an enlarged view of a portion of FIG. 2D;

FIG. 4A is a schematic cross-sectional view illustrating an effect according to the present disclosure;

FIG. 4B is a schematic cross-sectional view illustrating an effect according to the present disclosure;

FIG. 5A is a schematic cross-sectional view illustrating an electrode body according to the present disclosure;

FIG. 5B is a schematic cross-sectional view illustrating an electrode body according to the present disclosure;

FIG. 6A is a schematic cross-sectional view illustrating a positional relation between an electrode body and an outer encasement before and after a pressing process; and

FIG. 6B is a schematic cross-sectional view illustrating a positional relation between an electrode body and an outer encasement before and after a pressing process.

### DETAILED DESCRIPTION OF EMBODIMENTS

Hereinafter, a battery manufacturing method according to the present disclosure will be described in detail with reference to the drawings. Each drawing shown below is schematically shown, and the size and shape of each part are appropriately exaggerated for easy understanding. Further, in the present specification, an aspect in which another member is disposed with respect to a certain member is expressed as follows. When simply referred to as “on” or “below”, unless otherwise noted, it includes both placing other members directly above or below one member and placing other members above or below one member via another member so as to be in contact with one member.

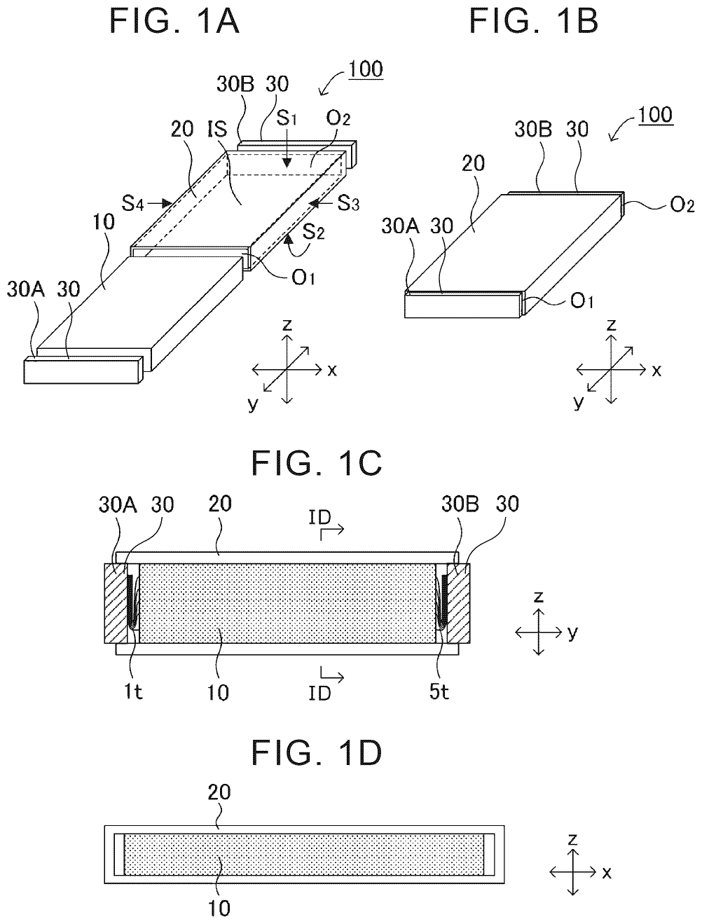

FIGS. 1A and 1B are schematic perspective views illustrating battery manufacturing methods in accordance with the present disclosure. FIGS. 1C and 1D are schematic cross-sectional views illustrating a battery manufacturing method according to the present disclosure. Specifically, FIG. 1A is a schematic perspective view illustrating components constituting a battery. FIG. 1B is a schematic perspective view illustrating the disclosed batteries. FIG. 1C is a schematic cross-sectional view taken along y-z plane of the battery shown in FIG. 1B. FIG. 1D is an ID-ID cross-sectional view of FIG. 1C. In FIG. 1A, for convenience, the positive electrode tab (for example, the positive electrode tab 5t in FIG. 1C) and the negative electrode tab (for example, the negative electrode tab 1t in FIG. 1C) are omitted.

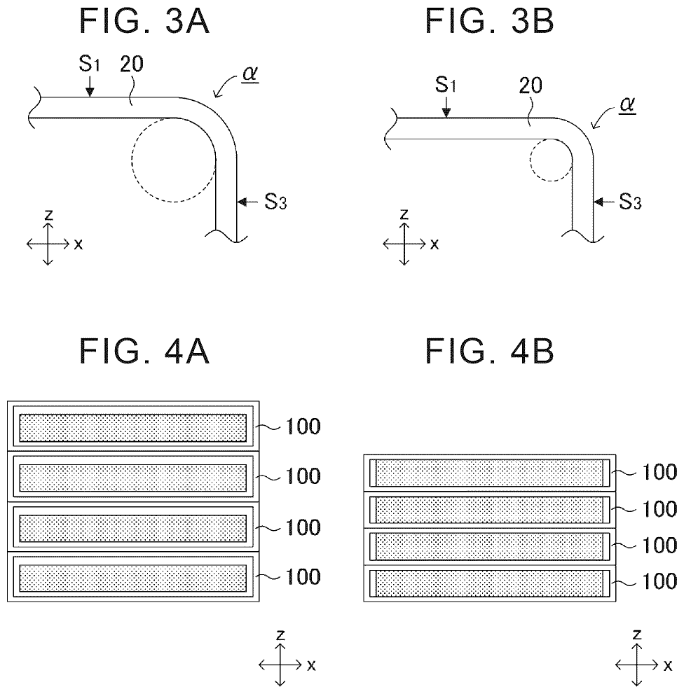

As shown in FIG. 1A, in battery manufacturing method, the outer encasement 20 is prepared (preparation step). The outer encasement 20 satisfies (i) to (iii) below. Specifically, (i) the outer encasement 20 includes a first face S₁, a second face S₂ opposite the first face S₁, a third face S₃ connecting the first face S₁ and the second face S₂, and a fourth face S₄ connecting the first face S₁ and the second face S₂ and also opposite the third face S₃. The (ii) outer encasement 20 has an inner space IS composed of a first face S₁, a second face S₂, a third face S₃, and a fourth face S₄, and an opening O (O₁, O₂) located at an end portion of the inner space IS. Further, the (iii) outer encasement 20 has a corner portion a having a curved shape, as shown in FIG. 3A described later. The corner portion a is disposed on at least one of both end portions of the side formed by the third face S₃ in a cross section perpendicular to the first face S₁ and the third face S₃ at the end portion of the outer encasement 20. Further, although not particularly illustrated, the outer encasement has a corner portion having a curved shape in at least one of both end portions of the side formed by the fourth face.

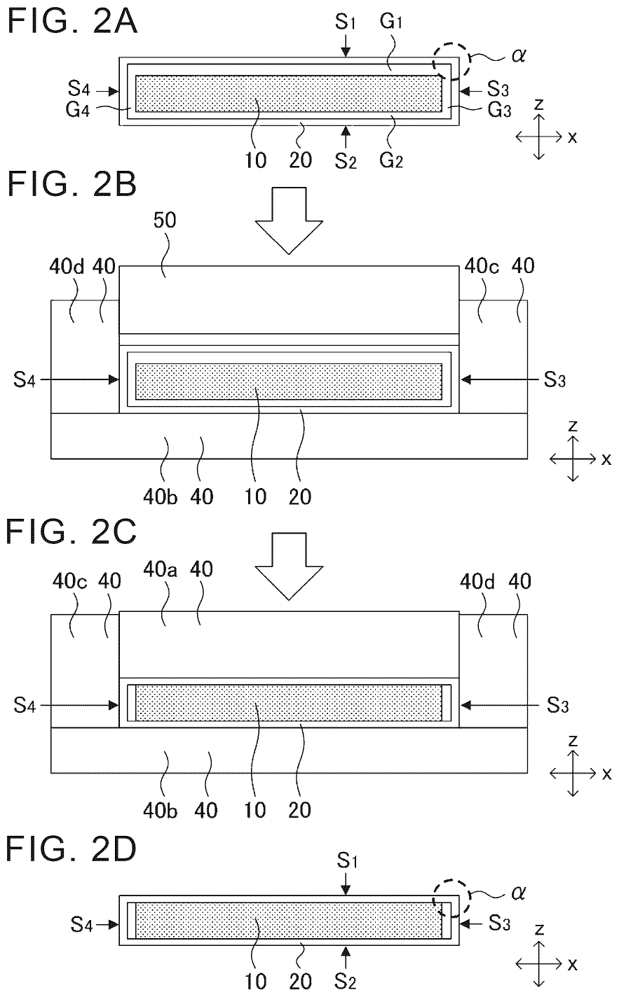

Next, as shown in FIG. 1A, the electrode body 10 is inserted into the inner space IS of the outer encasement 20 through the opening O of the outer encasement 20 (inserting step). The electrode body 10 shown in FIG. 1A has a square shape. Further, as shown in FIG. 2A, when the electrode body 10 is inserted into the outer encasement 20, a gap G2 is generated between the electrode body 10 and the second face S₂ of the outer encasement 20. The gap G₂ is a gap caused by a surface condition (for example, a bend, a waviness, or an unevenness) of the electrode body 10. Although not shown in the drawings, a part of the electrode body is in contact with the second face of the outer encasement due to the weight of the electrode body. As shown in FIG. 2A, a gap G₁ is formed between the electrode body 10 and the first face S₁ of the outer encasement 20. The gap G₁ is the sum of the gap caused by the surface condition of the electrode body 10 and the gap required for inserting the electrode body 10 into the outer encasement 20. Further, in order to insert the electrode body 10 into the outer encasement 20, a gap G₃ is generated between the electrode body 10 and the third face S₃ of the outer encasement 20, and a gap G₄ is generated between the electrode body 10 and the fourth face S₄ of the outer encasement 20.

Next, as shown in FIG. 2B, the electrode body 10 and the outer encasement 20 are placed on the holding member 40b. The first face S₁ is pressed toward the electrode body 10 by the press member 50 while the relative positions of the third face S₃ and the fourth face S₄ are fixed by the holding member 40c, 40d (pressing step). As a result, as shown in FIGS. 2C and 2D, the gap G and the gap G₂ disappear. As described above, the gap G₁ and the gap G₂ can be reduced by the pressing process. Further, FIG. 3A is an enlarged view of a corner portion a shown in FIG. 2A, and FIG. 3B is an enlarged view of a corner portion a shown in FIG. 2D. As shown in FIGS. 3A and 3B, by the pressing process, by the bending radius of the corner portion a is reduced, the excess of the outer encasement 20 is absorbed. Next, as shown in FIG. 1B, a lid body 30 (30A, 30B) is disposed in the opening O (O₁, O₂) (a lid body disposing step). As a result, the battery 100 is obtained.

According to the present disclosure, the gap G₁ and the gap G₂ can be reduced by performing a predetermined pressing process, so that a battery with good volume-efficiency can be obtained. As described above, when the electrode body is inserted into the inner space of the outer encasement through the opening, the size of the opening needs to be larger than the size of the electrode body. Accordingly, the volume of the inner space of the outer encasement is also usually larger than the volume of the electrode body. As a consequence, an excessive gap is formed in the inner space of the outer encasement, and thus the volume-efficiency of the battery 100 is reduced, for example, as shown in FIG. 4A. On the other hand, according to the present disclosure, the gap G₁ and the gap G₂ can be reduced by performing a predetermined pressing process, and thus, for example, as shown in FIG. 4B, a battery 100 with good volumetric efficiency can be obtained. Furthermore, since the gap G₁ and the G₂ have the heat insulating property, if the gap G₁ and the G₂ are present, the heat dissipation property of the batteries becomes low. On the other hand, in the present disclosure, the heat dissipation property of the batteries can be improved by reducing the gap G₁ and the gap G₂. As shown in FIGS. 2B and 2C, the first face S₁ may be pressed by the press member 50 having a flat surface. In this case, the surface state (e.g., bending, waviness, unevenness) of the electrode body 10 can be made flat, and the volume efficiency of the battery can be further improved.

### 1. Preparation Process

The preparation step is a step of preparing the outer encasement satisfying the following (i) to (iii).

As shown in FIG. 1A, (i) the outer encasement 20 includes a first face S₁, a second face S₂ opposite the first face S₁, a third face S₃ connecting the first face S₁ and the second face S₂, and a fourth face S₄ connecting the first face S₁ and the second face S₂ and also opposite the third face S₃. The first face S₁ and the second face S₂ usually correspond to the main surface, and the third face S₃ and the fourth face S₄ usually correspond to the side surface.

Further, as shown in FIG. 1A, the (ii) outer encasement 20 has a first face S₁, a second face S₂, a third face S₃, an inner space IS constituted by a fourth face S₄, and an opening O (O₁, O₂) located at an end portion of the inner space IS. The outer encasement 20 shown in FIG. 1A has two openings O₁ and O₂ opposite each other. On the other hand, although not particularly shown, the outer encasement may have only one opening. The outer encasement may then have a fifth face instead of the opening O₂ shown in FIG. 1A.

As shown in FIGS. 1A and 3A, the (iii) outer encasement 20 has a corner portion a having a curved shape. The corner portion α is disposed on at least one of both end portions of the side formed by the third face S₃ in a cross section perpendicular to the first face S₁ and the third face S₃ at the end portion of the outer encasement 20. Further, the corner portion α is disposed on at least one of both end portions of the side formed by the fourth face S₄. The outer encasement in the present disclosure may have a corner portion having a curved shape at at least one of both end portions of the side formed by the third face, and each of the end portions of the side formed by the third face may have a corner portion. Similarly, the outer encasement in the present disclosure may have a corner portion having a curved shape at at least one of both end portions of the side formed by the fourth face, and cach of the end portions of the side formed by the fourth face may have a corner portion.

The outer encasement in the present disclosure may be a case-type outer encasement or a laminate-type outer encasement. The case-type outer encasement is, for example, an outer encasement made of metal. For example, aluminum or an aluminum alloy (e.g., A1050-H18, A3003-H18) may be used as a component of the case-type outer encasement. Alternatively, a material obtained by performing plastic working on aluminum or an aluminum alloy (for example, A1050-O, A3003-O) and performing work hardening may be used. Further, the thickness of the case-type outer encasement is not particularly limited, and is selected to the extent that a desired rigidity can be obtained. In addition, the case-type outer encasement may be subjected to an insulating treatment (for example, an insulating resin coating, an insulating film, or an alumite treatment) on a surface facing the electrode body or the lid body.

The laminate-type outer encasement is also referred to as a pouch-type outer encasement, and is an outer encasement using a laminate film. The laminate-type outer encasement includes at least an inner resin layer and a metal layer. The inner resin layer functions as a sealant layer. The inner resin layer preferably contains a thermoplastic resin. Examples of the thermoplastic resin include polyolefins such as polyethylene and polypropylene, polystyrene, and polyvinyl chloride. The thickness of the inner resin layer is not particularly limited, but is, for example, 30 μm or more and 150 μm or less.

The metal layer functions as a barrier layer. Examples of the metal used in the metal layer include aluminum, an aluminum alloy, and stainless steel. The thickness of the metal layer is not particularly limited, but is, for example, 20 μm or more and 100 μm or less. In addition, the laminate-type outer encasement may have an outer resin layer on a side opposite to the inner resin layer with respect to the metal layer. The outer resin layer functions as an insulating layer or a protective layer. The outer resin layer preferably contains a thermoplastic resin. Examples of the thermoplastic include polyesters such as polyethylene terephthalate (PET) and nylons. The thickness of the outer resin layer is not particularly limited, but is, for example, 20 μm or more and 100 μm or less.

### 2. Insertion Process

The insertion step in the present disclosure is a step of inserting the electrode body into the inner space of the outer encasement through the opening of the outer encasement. For example, in FIG. 1A shown in the drawing, by moving the electrode body 10 along the y-direction with respect to the outer encasement 20, the electrode body 10 can be inserted into the inner space IS through the opening O₁.

The electrode body according to the present disclosure functions as a power generation element of a battery. The electrode body usually has a square shape. The electrode body generally includes a positive electrode current collector, a positive electrode active material layer, an electrolyte layer, a negative electrode active material layer, and a negative electrode current collector in this order in the thickness direction.

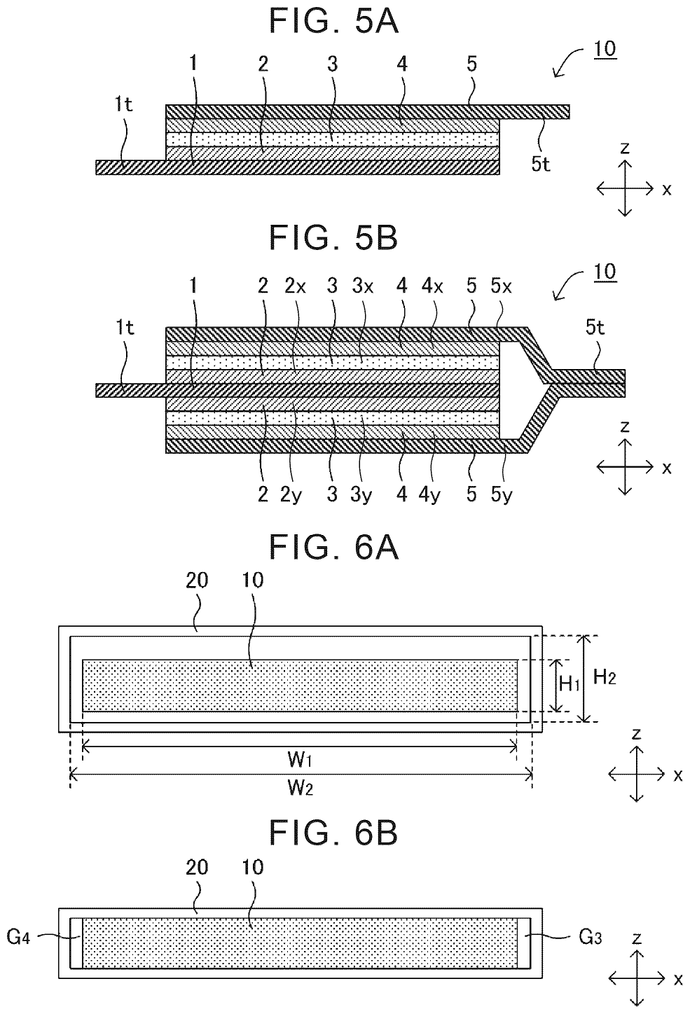

FIGS. 5A and 5B are schematic cross-sectional views illustrating an electrode body according to the present disclosure. The electrode body 10 shown in FIG. 5A includes a negative electrode current collector 1, a negative electrode active material layer 2, an electrolyte layer 3, a positive electrode active material layer 4, and a positive electrode current collector 5 in this order in the thickness direction (z direction). The negative electrode current collector 1 has a negative electrode tab 1t for connecting to a negative electrode terminal (not shown), and the positive electrode current collector 5 has a positive electrode tab 5t for connecting to a positive electrode terminal (not shown).

The electrode body 10 shown in FIG. 5B includes a negative electrode current collector 1, a negative electrode active material layer 2x, an electrolyte layer 3x, a positive electrode active material layer 4x, and a positive electrode current collector 5x, and a negative electrode active material layer 2y, an electrolyte layer 3y, a positive electrode active material layer 4y, and a positive electrode current collector 5y. The negative electrode active material layer 2x, the electrolyte layer 3x, the positive electrode active material layer 4x, and the positive electrode current collector 5x are arranged in this order in the thickness direction (z direction) from one surface of the negative electrode current collector 1. The negative electrode active material layer 2y, the electrolyte layer 3y, the positive electrode active material layer 4y, and the positive electrode current collector 5y are arranged in this order in the thickness direction (z direction) from the other surface of the negative electrode current collector 1.

Note that, in FIGS. 5A and 5B, the positive electrode tab 5t and the negative electrode tab 1t are arranged so as to face each other on the side surface of the electrode body 10, and so-called both tab configurations are formed. On the other hand, although not particularly shown, the positive electrode tab and the negative electrode tab may be disposed on the same side surface of the electrode body, and a so-called single tab structure may be formed.

The positive electrode active material layer contains at least a positive electrode active material. The positive electrode active material layer may further contain at least one of an electrolyte, a conductive material, and a binder. Examples of the positive electrode active material include an oxide active material. Examples of the oxide active material include rock salt layered active materials such as LiNi_{1/3}Co_{1/3}Mn_{1/3}O₂, LiNi_{0.8}Co_{0.15}Al_{0.05}O₂, spinel-type active materials such as LiMn₂O₄, and olivine-type active materials such as LiFePO₄. The shape of the positive electrode active material is, for example, particulate.

The electrolyte may be a solid electrolyte or a liquid electrolyte. The solid electrolyte may be an organic solid electrolyte such as a gel electrolyte or an inorganic solid electrolyte such as a sulfide solid electrolyte or an oxide solid electrolyte. Among them, the solid electrolyte is preferably a sulfide solid electrolyte. This is because the ion conductivity is high. Examples of the conductive material include carbon materials. Examples of the binder include a rubber-based binder and a fluoride-based binder.

The negative electrode active material layer contains at least a negative electrode active material. The negative electrode active material layer may further contain at least one of an electrolyte, a conductive material, and a binder. Examples of the negative electrode active material include a metal active material such as Li, Si, Sn, a carbon active material such as graphite, and an oxide active material such as Li₄Ti₅O₁₂.

The negative electrode active material is preferably a Si active material. This is because it is possible to increase the capacity of the battery. Si active material is an active material containing Si as a main component. Si active material may be a Si alone, may be a Si alloy, or may be a Si oxide. Si active material preferably has a clathrate II type crystalline phase. This is because volume change due to charge and discharge can be suppressed. The shape of the negative electrode active material is, for example, a particulate shape or a foil shape. The electrolyte, the conductive material, and the binder are the same as those described above.

The electrolyte layer is disposed between the positive electrode active material layer and the negative electrode active material layer, and contains at least an electrolyte. The electrolyte may be a solid electrolyte or a liquid electrolyte. The electrolyte is similar to those described above. The electrolyte layer may be a solid electrolyte layer containing a solid electrolyte. Further, the solid electrolyte is preferably a sulfide solid electrolyte. In general, a battery having a solid electrolyte layer containing an inorganic solid electrolyte is referred to as an all-solid body-state battery.

The positive electrode current collector collects current from the positive electrode active material layer. Examples of the material of the positive electrode current collector include metals such as aluminum, SUS, and nickel. Examples of the shape of the positive electrode current collector include a foil shape. The positive electrode current collector usually has a positive electrode tab for connection with a positive electrode terminal. The negative electrode current collector collects the negative electrode active material layer. Examples of the material of the negative electrode current collector include metals such as copper, SUS, and nickel. Examples of the shape of the negative electrode current collector include a foil shape. The negative electrode current collector usually has a negative electrode tab for connection with a negative electrode terminal. In addition, the electrode body in the present disclosure may have an insulating film on at least a part of the surface in order to improve the insulating property. Further, the corner portion of the electrode body may be chamfered.

### 3. Press Process

The pressing step according to the present disclosure is a step of pressing at least one of the first face and the second face toward the electrode body. The pressing step is performed in a state in which the relative positions of the third face and the fourth face are fixed or in a state in which at least one of the third face and the fourth face is pressed toward the electrode body after the inserting step.

As shown in FIGS. 2A and 2B, when pressing at least one of the first face S₁ and the second face S₂ toward the electrode body 10, the relative positions of the third face S₃ and the fourth face S₄ may be fixed by the holding member 40c, 40d. Examples of the holding member 40c, 40d include a mold. On the other hand, although not particularly shown, when pressing at least one of the first face and the second face toward the electrode body, at least one of the third face and the fourth face may be pressed toward the electrode body. At this time, one of the third face and the fourth face may be pressed toward the electrode body, and the other position may be fixed. In addition, both the third face and the fourth face may be pressed toward the electrode body.

In the pressing step, at least one of the first face S₁ and the second face S₂ is pressed toward the electrode body. Thus, it is possible to reduce the gap G₁ and the gap G₂ (for example, the gap G₁ and the gap G₂ shown in FIG. 2A). In the present disclosure, one of the first face and the second face may be pressed toward the electrode body, and the other position may be fixed. In addition, both the first face and the second face may be pressed toward the electrode body. After the pressing step, the sum of the gap G₁ and the gap G₂ is preferably equal to or less than 0.1 mm.

FIG. 6A is a schematic cross-sectional view illustrating the positional relationship between the electrode body and the outer encasement prior to the pressing process, FIG. 6B is a schematic cross-sectional view illustrating the positional relationship between the electrode body and the outer encasement after the pressing process. As shown in FIG. 6A, the length of the electrode body 10 in the thickness direction (z direction) is set to H₁. Let H₂ be the length (inner dimension) of the outer encasement 20 in the thickness direction (z direction). Let W₁ be the length of the electrode body 10 in the width-direction (x-direction). Let W₂ be the length (inner dimension) of the outer encasement 20 in the widthwise direction (x direction). The difference between H₂ and H₁, for example, is less than 0.10 mm or 0.80 mm, may be 0.15 mm or less 0.30 mm. The difference between the W₂ and the W₁, for example, is equal to or less than 0.10 mm or more and equal to or less than 0.80 mm, and may be equal to or less than 0.15 mm or less than 0.30 mm.

As shown in FIG. 6B, after the pressing step, the gap G₃ and the gap G₄ may remain. By leaving the gap G₃ and the gap G₄, it is easy to arrange the lid body. On the other hand, although not specifically illustrated, the gap G₃ and the gap G₄ may disappear. For example, when pressing at least one of the first face and the second face toward the electrode body, pressing at least one of the third face and the fourth face toward the electrode body can eliminate the gap G₃ and the gap G₄.

By the pressing process, the bending radius of the corner portion having a curved shape (for example, the corner portion a shown in FIG. 2A) decreases (FIG. 3A and FIG. 3B). Before the pressing step, the bending radii of the corner portions are not particularly limited, but are, for example, 0.5 mm or more and 1.5 mm or less, respectively. On the other hand, after the pressing step, the bending radii of the corner portions are not particularly limited, but are, for example, 0.1 mm or more and 0.5 mm or less, respectively. It is preferable that the bending radii of all (four) of the corner portions a decrease before and after the pressing step.

### 4. Lid Body Placement Process

The lid body disposing step in the present disclosure is a step of disposing the lid body in the opening before the pressing step or after the pressing step. The lid body is a member used to seal the opening.

The material constituting the lid body is not particularly limited, and examples thereof include metals such as aluminum, aluminum alloys, stainless steel, iron, copper, and nickel. Further, a resin may be used as a material constituting the lid body. The lid body may be a terminal. For example, in the illustrated FIG. 1C, the lid body 30A is a negative electrode terminal electrically connected to the negative electrode tab 1t, and the lid body 30B is a positive electrode terminal electrically connected to the positive electrode tab 5t. On the other hand, the lid body may not have a terminal function. Although not particularly shown, a through-hole may be provided in the lid body, and a terminal may be disposed in the through-hole. In addition, the lid body may be subjected to an insulating treatment (for example, an insulating resin coating or an insulating film bonding) on a surface of the lid body facing the outer encasement and the terminal.

### 5. Battery

Examples of the battery in the present disclosure include a secondary battery such as a lithium ion secondary battery. Further, applications of the batteries include, for example, power sources of vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Further, the battery may be used as a power source for a moving object (for example, a railway, a ship, or an aircraft) other than the vehicle, or may be used as a power source for an electric product such as an information processing apparatus.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

### EXAMPLE 1

A seamless tube was used to prepare an outer encasement (inner dimension: 73.6 mm×6.68 mm) as shown in FIG. 1A. In addition, a metallic piece (dimension: 73.4 mm×6.48 mm, without chamfer) imitating the electrode body was prepared. The metal piece simulates an electrode body having no bends, undulations, or irregularities. When the metal piece was inserted into the outer encasement by manual work, it was possible to assemble it smoothly. Thereafter, in a state where the relative positions of the third face and the fourth face of the outer encasement were fixed, the first face of the outer encasement was pressed toward the metal piece. It was confirmed that the gap G₁ and the gap G₂ shown in FIG. 2A disappeared. Thereafter, a lid body was disposed in each of the two openings of the outer encasement, and a simulated battery was obtained.

### EXAMPLE 2

A seamless tube was used to prepare an outer encasement (inner dimension: 73.6 mm×6.68 mm) as shown in FIG. 1A. Further, a metallic piece imitating the electrode body (dimension: 73.5 mm×6.58 mm, C chamfered 0.5 mm at four corner portions) was prepared. When the metal piece was inserted into the outer encasement by manual work, it was possible to assemble it smoothly. Thereafter, in a state where the relative positions of the third face and the fourth face of the outer encasement were fixed, the first face of the outer encasement was pressed toward the metal piece. It was confirmed that the gap G₁ and the gap G₂ shown in FIG. 2A disappeared. Thereafter, a lid body was disposed in each of the two openings of the outer encasement, and a simulated battery was obtained.

### COMPARATIVE EXAMPLE 1

A seamless tube was used to prepare an outer encasement (inner dimension: 73.6 mm×6.68 mm) as shown in FIG. 1A. Further, a metallic piece imitating the electrode body (dimension: 73.6 mm×6.68 mm, C chamfered 0.5 mm at four corner portions) was prepared. When the metal piece was manually inserted into the outer encasement, it could not be assembled.

What is claimed is:

1. A battery manufacturing battery manufacturing a battery that includes an electrode body, an outer encasement, and a lid body, the battery manufacturing method comprising:
preparing the outer encasement that satisfies (i) to (iii) in which
(i) the outer encasement includes a first face, a second face opposite the first face, a third face connecting the first face and the second face, and a fourth face connecting the first face and the second face and also opposite the third face,
(ii) the outer encasement includes an inner space defined by the first face, the second face, the third face, and the fourth face, and an opening situated at an end portion of the inner space,
(iii) in a cross-section perpendicular to the first face and the third face at an end portion of the outer encasement, the outer encasement includes a corner portion with a curved shape on at least one of both end portions of a side made up of the third face, and also includes a corner portion with a curved shape on at least one of both end portions of a side made up of the fourth face;
inserting the electrode body into the inner space through the opening;
pressing at least one of the first face and the second face toward the electrode body, following the inserting, in a state in which relative positions of the third face and the fourth face are fixed, or in a state in which at least one of the third face and the fourth face is pressed toward the electrode body; and
placing the lid body in the opening prior to the pressing or following the pressing.

2. The battery manufacturing method according to claim 1, wherein the outer encasement includes, in the cross-section perpendicular to the first face and the third face at the end portion of the outer encasement, the corner portions each with the curved shape at both end portions of the side made up of the third face, and also the corner portions each with the curved shape at both end portions of the side made up of the fourth face.

3. The battery manufacturing method according to claim 2, wherein:
prior to the pressing, bending radii of the four corner portions are each no less than 0.5 mm and no more than 1.5 mm; and
following the pressing, the bending radii of the four corner portions are cach no less than 0.1 mm and no more than 0.5 mm.

4. The battery manufacturing method according to claim 1, wherein the electrode body includes a solid electrolyte.

5. The battery manufacturing method according to claim 1, wherein the placing is performed following the pressing.
